(19) United States
(12) Patent Application Publication
(10) Pub. No.: US 2019/0147553 A1
(43) Pub. Date: May 16, 2019

(54) STORING LINKED LISTS OF MINERAL RIGHTS TRANSACTIONS IN DIRECTED ACYCLIC GRAPHS OF CRYPTOGRAPHIC HASH POINTERS

(71) Applicant: TitleFlow LLC, Lubbock, TX (US)

(72) Inventors: Ryan Reber, Lubbock, TX (US); Ryan Hutchinson, Lubbock, TX (US)

(21) Appl. No.: 16/191,353

(22) Filed: Nov. 14, 2018

Related U.S. Application Data
(60) Provisional application No. 62/585,815, filed on Nov. 14, 2017.

(51) Int. Cl. G06Q 50/16; G06Q 20/38; G06Q 20/36

(52) U.S. Cl. CPC G06Q 50/167; G06Q 20/3825; G06Q 2220/00; G06Q 20/389; G06Q 20/36

(57) ABSTRACT

Provided is a process that uses a directed acyclic graph of cryptographic hash pointers managed with a consensus algorithm to managing documents relating to transactions in mineral rights.

### CROSS-REFERENCE TO RELATED APPLICATIONS

This application claims the benefit of U.S. Provisional Application No. 62/585,815, filed on 14 Nov. 2017, the entirety of which is incorporated by reference herein.

### BACKGROUND

### 1. Field

The present disclosure relates generally to decentralized applications and, more specifically, to applications of directed acyclic graphs of cryptographic hash pointers managed with consensus algorithms to managing documents relating to transactions in mineral rights.

### 2. Description of the Related Art

It is common for computers to be used in exchanges transferring ownership of real property rights. Examples of such transactions include buying and selling real estate, cars, mineral rights, water rights, etc. Before engaging in such transactions, it is common for the buyer to verify that title is held be the seller.

Currently, title ownership is verified by independent companies combing through county records and producing reports. This process is not fool proof, and as a result, parties often purchase title insurance when title is exchanging hands to protect their interests. Various technologies are often used to store and timestamp the creation of title or the transaction of titles in centralized locations or in a single location, whether that be a centralized database or a piece of paper. In instance where creation of title or transaction of tiles are recorded in hard copy, like a piece of paper, the centralized locations may be relatively localized, like county offices, and thus relatively disparate on a broader scale. Historically, the above methods, aside from verifying chain of title in person (such as by visiting county tax offices, assuming there are no errors in their records), are subject to untraceable fraudulent activity. This is evidenced, in part, by the common practice of purchasing title insurance, as verification of title ownership is often based on trusting the company a party is choosing to conduct the transaction with.

### SUMMARY

The following is a non-exhaustive listing of some aspects of the present techniques. These and other aspects are described in the following disclosure.

Some aspects include a process that uses a directed acyclic graph of cryptographic hash pointers managed with a consensus algorithm to managing documents relating to transactions in mineral rights.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block logical and physical architecture diagram of a computing environment for mineral rights transactions on a blockchain in accordance with some embodiments of the present techniques;

FIG. 2 is a flowchart of an example of a process executed by an authority and/or a computing node with a smart contract in accordance with some embodiments of the present techniques;

FIG. 3 is a flowchart of an example of a process executed by an authority and/or a computing node with a smart contract in accordance with some embodiments of the present techniques; and

FIG. 4 is a block diagram of an example computing device with which the above-described techniques may be implemented in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of real-estate document management software. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments provide a process that uses notarization with Solidity™ to capture and store titles and titles history in ether contracts on the Ethereum™ blockchain in a way that allows for instant verification of any form of title or title history. To handle the ability to store, timestamp, and authorize the creation of transaction of titles on the decentralized Ethereum block chain or other block chains, embodiments may include the estimation of gas needed, the purchase of Ether for gas, and creation a data structure to allow for the smallest amount of gas to be used for verification and storage/verification.

The process, in some embodiments, starts by having access to the Ethereum wallet of an entity trying to execute a title transaction. An entity may be a person, company, authorized party acting on behalf of a person or company, an authority, or other entity discussed herein.

In some embodiments, title information is translated into a schema suitable for storage and processing on the blockchain. By way of example, title information may be translated from a title schema, which may differ between countries, states, counties, etc. for a given type of title, into a unified title type schema. A unified title type schema may define the various possible characteristics that pertain to a specific type of title, although titles of that type may have different title schemas (e.g., different states or title processors may utilize different formats, fields, units, etc. to describe similar types of information). Thus, the translation may comprise the processing of title information from the title schema into title information in the unified title type schema. Title information in the unified title type schema (or unified schema) may include information about the asset to which the title pertains. For example, where that asset is land ownership/rights, the information may include geolocation data for the asset, metes and bounds for the asset, topographical features of the asset, underground features of the asset, permissions and/or restrictions relative to one or more features or the asset, usage rights relative to one or more features or the asset, etc. Thus, rather than 10, 50, 100, or 1000 different entities referring to a similar aspect of an asset in as equally many different ways, if not more, the unifies schema translates title information into a uniform format. In other words, the title information in the unified schema enables expedited determinations about assets and, as explained below, the storing of that information into a data structure that is stored within the blockchain provides immutable recording of ownership and/or rights pertaining to an asset and/or features thereof. In other words,

In some embodiments, the unified schema specifies a hierarchy for at least some of the title information translated into the unified schema. The hierarchy may, for example, enumerate various dependencies or permissions pertaining to an asset or features thereof. Thus, for example, a subset of features or subset of an asset (e.g., a portion of the metes and bounds) may be associated with different permissions, restrictions, and/or usage rights. As a result, a given aspect in the title information in the unified schema for an asset may be used to identify other associated aspects. For example, if a party is interested in a given topographical feature of the asset (e.g., a hill for above-ground sand mining), the hierarchy may identify any restrictions associated with that operation (e.g., environmental restrictions), permissions associated with the feature or nearby features (e.g., a containment pond), and whether the title owner has the right to permit such activities. Further, if that party is interested in an easement to access that topographical feature, the hierarchy may identify restrictions (e.g., crossing of a navigable water feature or privately owned water feature), permissions, and usage rights associated with the metes and bounds pertaining to the easement (e.g., which may be a subset of the asset and also pertain to one or more features, like a water feature). In the example of an easement, the metes and bounds pertaining to the easement may span multiple assets. Where those assets are commonly owned, the hierarchy may identify those assets and include title information pertaining to those assets. Where those assets are not commonly owned, the hierarchy may identify adjacent assets (e.g., by an identifier in a blockchain such that permissions, restrictions, etc. may be identified for that asset).

In some embodiments, the title information in the unified schema may be stored into a data structure, which may be specified by the unified schema, that may be stored on the blockchain. For example, the unified schema may be operable to codify title information in the unified schema into the data structure. In some embodiments, the data structure is a vector for which the schema specifies a vector format, such as which elements (e.g., location in the vector having a value) of the vector correspond to title information from the unified schema. In other embodiments, the data structure is XML or JSON code having key-value pairs for which the schema specifies one or more keys and data types for corresponding values and the values correspond to title information from the unified schema. In some embodiments, the data structure includes both XML or JSON code and vectors, for example, a value of a key-value pair may be a vector. In some embodiments, the unified schema specifies a translation between XML or JSON code and a vector such that a vector may represent a compact version of the XML or JSON code. For example, a key of a key-value pair within XML or JSON code may be a location within the vector and the value of the key-value pair may be represented by a same or different value at that location, each of which may be specified by the unified schema. In turn, that vector may be translated back into XML or JSON code according to the unified schema.

After the data structure for a title has been created, in some embodiments, the process calculates a transaction fee, or amount of gas, that will be needed to effect a transaction associated with the title in the blockchain, such as executing a record of ownership of the title. The calculation, in some embodiments, will result in a total gas amount. This amount, in some embodiments, may then be multiplied by the price of gas desired and used to buy ether, if necessary, to increase an amount of ether in a wallet (e.g., of the entity requesting the transaction). After enough ether has been purchased to complete the transaction, in some embodiments, the process will send the title and gas to an Ethereum™ contract to store the title on the chain.

This process may tie the title itself to the Ethereum™ wallet of the title owner. In some embodiments, an authorized party may manage or have access to the wallet of the title owner to effect the transaction. In some embodiments, the transaction may be processed through an authority, like a signature authority, which reputably determines identities of the title owners and effects the transactions, which may include signing the transaction on behalf of the title owner or authorized party. The decentralization of the process and immutability of data stored in blockchains means that a complete history or ledger of the changes made to a title can be chained back to its initial entry into the blockchain. The data structure being used, in some embodiments, to store the title will either be a creation title entry or based on an existing entry. If it is based on an existing entry, in some embodiments, the data structure may include a cryptographic hash linking to the previous edition of the title for simplicity of finding the past title. Verification can still occur based on verification back to the entry in blockchain to irrefutably demonstrate no intervening conferment of rights or ownership. However, linking can simplify review (e.g., by an interested party) prior to verification.

A similar process, in some embodiments, may occur for verification of titles on the chain. The entity looking to verify may have access to an Ethereum™ wallet. This wallet, in some embodiments, will be used to purchase ether for the purchase of gas. The verification will start by looking at the most recent title in the chain and following the hash links back to see the changes made to the title or the creation of the title. Further, verification may include determining whether those entries are valid entries that are part of the immutable block chain, such as computing one or more cryptographic hashes based on hash links in a tree structure to verify the entry is both unchanged and stored in the immutable chain of blocks.

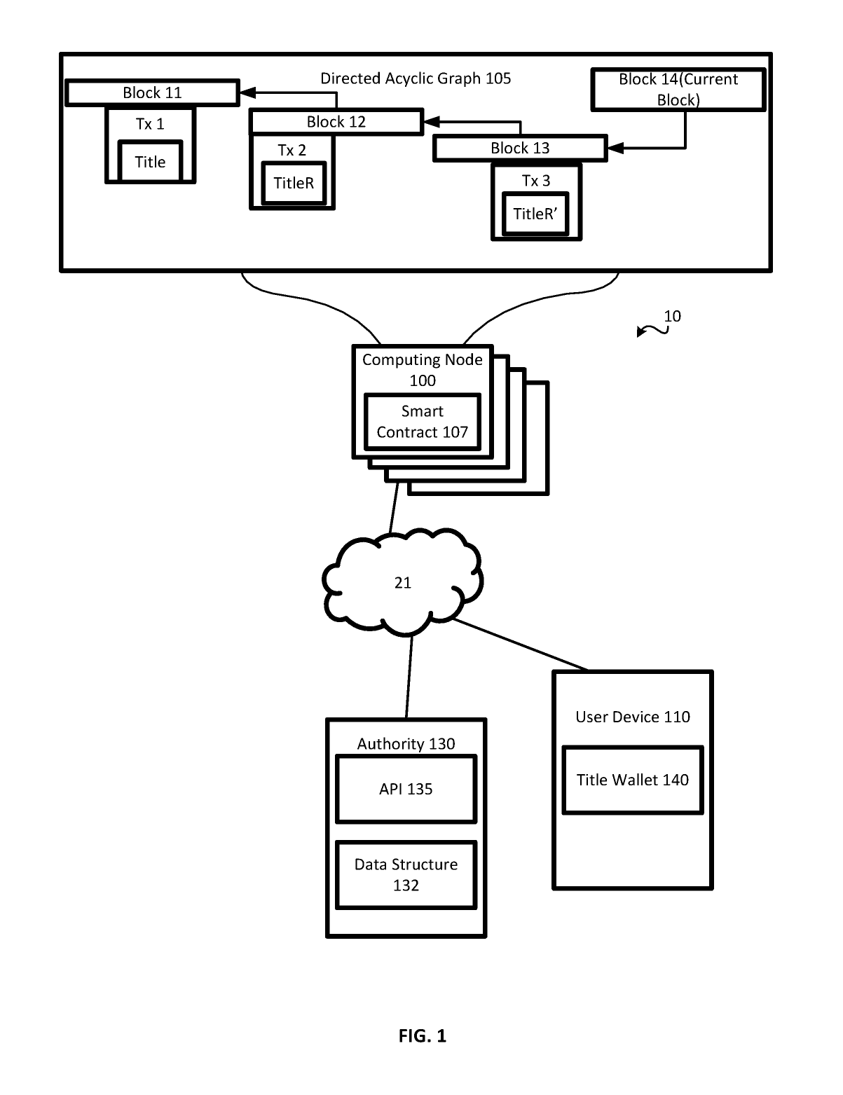

FIG. 1 is a block diagram depicting an environment 10 in which entities interact in at least some example embodiments. For example, FIG. 1 depicts an authority 130, a user device 110, and a computing node 100 which may communicate directly or indirectly over a network 21. In some embodiments, the network 21 includes the public Internet and a plurality of different local area networks. Depending on the embodiments, the authority 130 may communicate with a computing node 100 and one or more other entities over the network 21. Similarly, the computing node 100 may communicate with one or more other entities over the network 21.

The user device 110 may be a computing device of a user who desires to have their title information recorded in the blockchain. In some cases, the user device 110 may include a title wallet 140 which may store information about title information stored in the blockchain for which that user can show ownership of. In some cases, usage rights are also conferred, and verification process and records thereof may be tracked in a similar fashion.

The authority 130 may be a computing device or collection of computing device associated with a trusted party that processes title transactions and may process title transactions on a blockchain. In some embodiments, that authority 130 includes an API 135 for processing information associated with transactions and includes a data structure 132 for storing title information on a blockchain. The authority 130 may also configure and publish a smart contract 107, which may be executed by computing nodes 100 of a decentralized data store, like a blockchain. In some embodiments, the smart contract 107 may include some or all of the functionality of the API 135 and specify a data structure for title information. Further, in some embodiments, responsive to the functions in the smart contract 107, a computing node 100 may perform one or more of the operations discussed below with respect to the authority 130. In some embodiments the smart contract 107 may be configured to make calls to the API 135 of the authority 130 retrieve information, like translated title information according to the data structure 132.

In some embodiments, the computing node 100 is a computing node of a decentralized computing platform comprising many computing nodes. While only one computing node 100 is shown in detail, embodiments may include many more computing nodes, for instance, numbering in the dozens, hundreds, or thousands or more. In some embodiments, one or more of the computing nodes 100 may be rack-mounted computing devices in a data center, for instance, in a public or private cloud data center, or personal computing devices or servers in users' homes. In some embodiments, various ones of the computing nodes 100 may be geographically remote from one another, for instance, in different data centers and different users' homes, and geographically remote from other nodes and the other components illustrated. Thus, in some embodiments, the computing platform that the computing nodes operate is relatively to very decentralized where at least some of the computing nodes are operated by various different entities for various purposes. However, that is not to say that in some embodiments a computing node 100 or nodes may be collocated (or in some cases, all be deployed within a single computer cluster).

In example embodiments where computing nodes are part of a decentralized computing platform comprising many computing nodes it should be recognized that entities the like the user device 110 and authority 130 need not communicate with any one specific node. Rather, each may communicate with a different one/multiple of the computing nodes of the decentralized computing platform and also may communicate with different ones of the nodes at different times. Further, in some embodiments, one or more of the authority 130 and user device 110 may also be a node, include a node and/or operate a node or subset of functionality of a node, thereby operating as part of the decentralized computing platform or configured to communicate with at least some of the nodes (e.g., to submit and/or retrieve data, not substantially process data).

In some embodiments, the computing node 100 may operate upon various types of information stored by the decentralized computing platform. Examples include a directed acyclic graph 105 of cryptographic hash pointers, such as a blockchain or other tamper-evident, immutable, decentralized data stores. Other examples include various scripts in the scripting language of the decentralized computing platform executable by the computing node 100, for instance with verifiable computing, such that no single computing node 100 needs to be trusted. In some embodiments, these scripts or programs may be referred to as smart contracts 107, a term which should not be confused with a contract in law or other financial instrument. Rather, smart contracts refer to programs executable by the decentralized computing platform, which in some cases may be tamper-evident, immutable decentralized programs loaded to the decentralized computing platform by one of the components of the environment 10. For example, the authority 130 may publish a smart contract 107 to the decentralized computing platform such that the computing node 100 (and/or other nodes) may process information stored in the directed acyclic graph 105, and/or other information, according to one or more operations enumerated in the smart contract. A smart contract 107 can be a contract in the sense that the logic of the smart contract is immutable in some implementations once loaded to the decentralized computing platform and thus serves as a form of a commitment to a particular body of logic.

The term “immutable” should not be read to require that immutable data be written to a form of physical media that prevents subsequent writes (e.g., a ROM or write-once optical media). Rather, the term “immutable” refers to a data structure that does not support modifications to data once written. In some cases, this feature is afforded by making the data structure tamper evident, e.g., computationally infeasible to modify committed data without rendering the data structure internally inconsistent. In some cases, the data structure computational infeasibility of undetectable modifications may be afforded by chaining the above-described cryptographic hash values, such that verification of tampering consumes less than 100,000^{th} of the computing resources (e.g., in time or memory complexity) of computing resources needed to modify the data structure to be consistent with a modified previously written transactions.

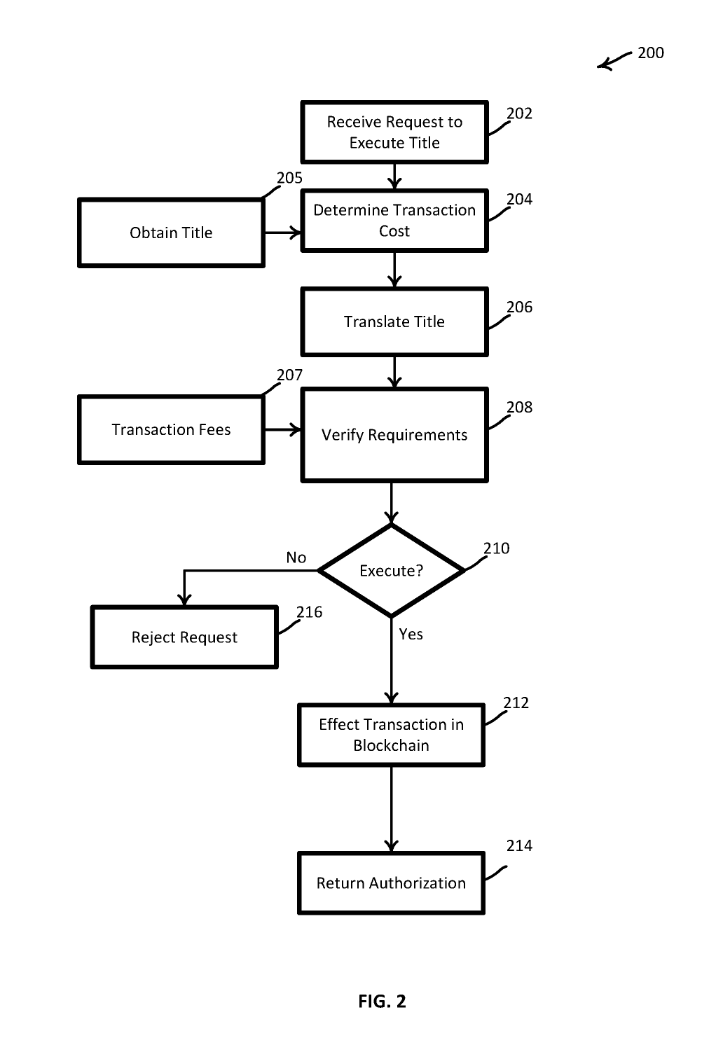

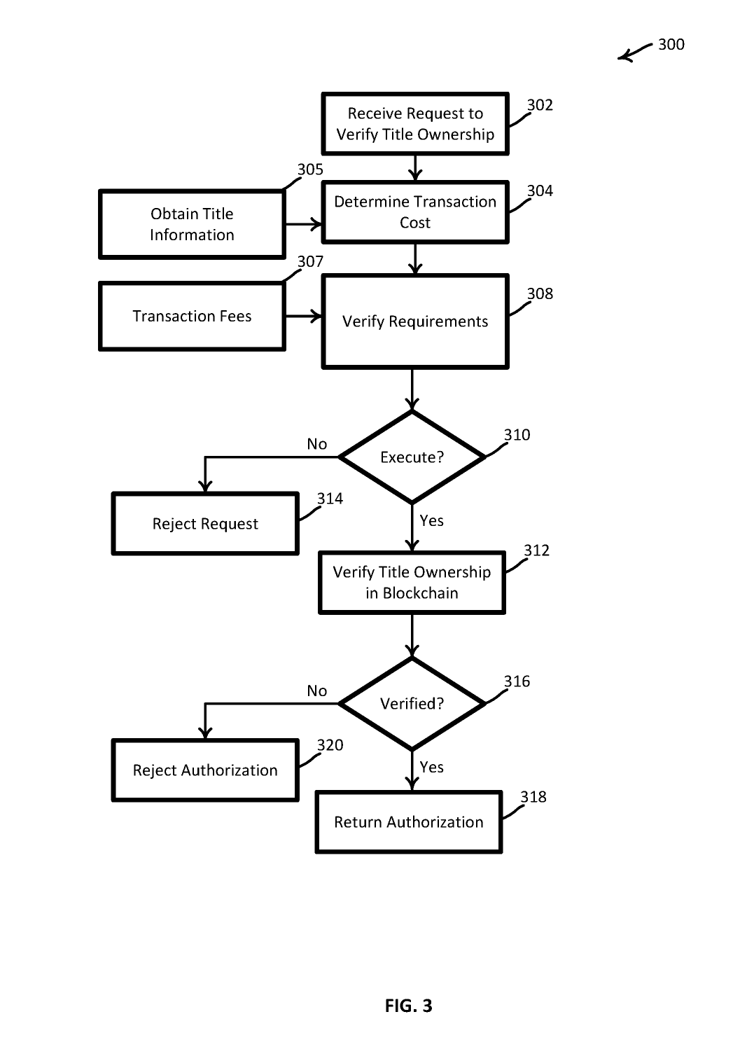

In some embodiments, the smart contracts may be stored in the directed acyclic graph 105 or otherwise published to this data repository, or in some cases, the smart contracts may be stored in a different tamper-evident, immutable, decentralized data store from that of the data upon which the smart contracts operate. One example smart contract 107 is shown, but it should be emphasized that there may be, and in some commercial implementations likely will be, multiple instances smart contracts with variations to implement new or different logic. Further, in some cases, the smart contracts may be composed of or reference other smart contracts or invoke or draw upon logic implemented outside of the decentralized computing platform. For example, a smart contract for performing a process like that in FIG. 2 (e.g., for title transfer) may in some instances call to another smart contract to perform a process like that in FIG. 3 (e.g., for verification of a title prior to transfer). Some smart contracts may interface with the outside world relative to the decentralized computing platform via an authority 130.

In some embodiments, smart contracts, like smart contract 107, may be callable by the various components of the environment 10. Additionally, various components of the environment 10, like the authority 130, may publish new smart contracts callable by the various components and the authority. For example, the components in some cases may execute a peer client application of the decentralized computing platform or otherwise send messages to application program interfaces for performing operations within the decentralized computing platform to call the smart contracts and receive results. In some embodiments, the smart contracts may have an address, for instance, in a data storage address space of the decentralized computing platform, like an address corresponding to a cryptographic hash of program code of the smart contracts. In some embodiments, the smart contracts may accept arguments, such as various variables that may be passed to the smart contract and which may be operated upon by logic of the smart contract. Examples of arguments and their variables may include references, like an address, to data within the decentralized computing platform and/or data for storage within the decentralized computing platform. In some cases, each smart contract may have a respective application program interface with a schema defined in an artifact of the corresponding smart contract that enumerates arguments that are required, arguments that are optional, default values for arguments, types of those arguments, and the like. Such smart contracts may be implemented on computing nodes 100 participating on an Ethereum blockchain protocol.

In some embodiments, an address of a smart contract 107 may be called with an API call including this document as a parameter. In some embodiments, the smart contract may respond to the API call by executing a transaction on the blockchain that records the document to the blockchain. This, in some cases, may include calculating a cryptographic hash value based on both the document and a cryptographic hash value of entries in the block chain through which the conveyed rights were previously conveyed to the conveyor. In some cases, a new entry created by the smart contract may include this cryptographic hash value and pointers to those other nodes. In some embodiments, every computing device executing a decentralized application implementing the block chain may execute a routing specified by the smart contract, and some embodiments may implement a consensus algorithm among those computing devices, like Paxos or Raft, to reach a consensus as to a result of executing the smart contract. The result may be stored in the block chain and this process may be repeated for subsequent transfers. Some embodiments may interrogate these records to verify title, e.g., by recreating the calculation of the cryptographic hash values along each link in a chain of cryptographic hash pointers and comparing the recalculated values to the values in the chain to confirm (in virtue of matches) that the records are authentic.

In some embodiments, the directed acyclic graph 105 comprising cryptographic hash pointers may provide a tamper-evident, immutable, decentralized data store to which the smart contracts are published and to which transactions accessed by the smart contracts are published, which in some cases may include output of the smart contracts as well as inputs to the smart contracts. In some embodiments, transactions recorded to or smart contracts published to the directed acyclic graph 105 may include storing all of the information of that transaction or smart contract (e.g., the program code of the logic of the smart contract that is executed by the computing nodes 100 (e.g., in a virtual-machine of the decentralized computing platform corresponding to a target of byte code into which smart contracts are interpreted) in content of nodes (e.g., a node in a tree of nodes, like a Merkle tree, and a given tree may be stored in a block) of the directed acyclic graph of cryptographic hash pointers. Cryptographic hash pointers pointing to those nodes include cryptographic hash values (as part of node content of the node that is pointing) that are based on node content (of the node to which is pointed) that includes the stored information (e.g., a transaction and transaction data), thereby defining a chain of cryptographic hash pointers that becomes increasingly computationally expensive to modify (while remaining internally consistent) in the event of attempted tampering as the chain increases in length or tree increases in size. In some embodiments, a plurality of different directed acyclic graphs of cryptographic hash pointers may store different subsets of the information, may store replicated instances of the information, or in some cases a single directed acyclic graph of cryptographic hash pointers may store all of this information. In some cases, the directed acyclic graph is a sub-graph of a larger graph with a cycle, and in some cases the directed acyclic graph includes unconnected subgraphs.

In some embodiments, transactions are published to the directed acyclic graph 105 of cryptographic hash pointers is achieved by storing a cryptographic hash digest of the information in node content of the directed acyclic graph of cryptographic hash pointers. In some embodiments, node content may be a transaction with transaction data. In some embodiments, node content may be a transaction for storing data, like a sstore or Txdata function, which may also include transaction fees for the transaction to store the data. In some cases, that transaction for data storage includes a cryptographic hash (or hashes) of title information stored outside of the directed acyclic graph 105 of cryptographic hash pointers, but that outside title information and an appended timestamp and address in a data store (e.g., like that of an authority 130 or other entity) may be input to a cryptographic hash function to output a cryptographic hash value. That cryptographic hash value (or other hash digest) may be stored as node content of the directed acyclic graph 105 of cryptographic hash pointers. The title information stored outside of the graph 105 may then be verified as having been untampered with by recalculating the cryptographic hash value based on the asserted address, time, and transaction information and comparing the recalculated cryptographic hash value to the cryptographic hash value stored by the transaction in the directed acyclic graph of cryptographic hash pointers. Upon determining that the hash values match, the title/transaction data may be determined to have not been subject to tampering, or upon determining that the values do not match, the transaction/title may be determined to have been tampered with. Further, to verify that the cryptographic hash value in the directed acyclic graph has not been tampered with, some embodiments may recalculate cryptographic hash values along a chain of cryptographic hash pointers to confirm that the recalculated values match those in the directed acyclic graph, thereby indicating the absence of tampering (or upon detecting a mismatch, indicating the presence of tampering).

In some embodiments, the on-chain title information having the data structure specified by the unified schema may be stored as node content by one or more transactions may be a machine-readable portion, such as a portion of key-value pairs in dictionaries encoded as a hierarchical data serialization format, like JavaScript™ object notation (JSON) or extensible markup language (XML). In some embodiments, the off-chain portion may be a human-readable format including unstructured natural language text that describes in prose information of the transaction. Or in some embodiments, this allocation may be reversed, intermingled, or otherwise differently arranged, which is not to suggest that any other feature herein is not also amenable to variation relative to the arrangements described.

In some embodiments, content of nodes of the directed acyclic graph 105 of cryptographic hash pointers may be verified as having not been subject to tampering by determining whether that content is consistent with one or more chains, or other associative data structures (e.g., trees), of cryptographic hash pointers of the directed acyclic graph. In some embodiments, nodes of the directed acyclic graph of cryptographic hash pointers may include as node content a node identifier (e.g., an address in the graph) that distinguishes a node from other nodes of the graph, identifiers or one or more other nodes of the graph to which a cryptographic hash pointer of that node points, and an associated cryptographic hash values based on node content of those other identified nodes to which the cryptographic hash pointers point (in some cases, the pointing is from one and only one node to one and only one node for adjacent nodes). As additional nodes are appended to the directed acyclic graph, a chain of cryptographic hash pointers may be formed such that each subsequent node includes as node content one or more cryptographic hash values based upon some, and in some cases all of the previously published information published to the directed acyclic graph of cryptographic hash pointers. In some embodiments, following these pointers may be requested by a sload function which verifies that stored title information has not be tampered with or subject to other transactions.

The directed acyclic graph 105 of cryptographic hash pointers need not be referred to as a graph, or as having nodes or edges, in program code to constitute a graph, provided that a data structure affords the same or similar functionality, even if that data structure bears different labels. Similar qualifications apply to title information and transactions described herein. For instance, graphs may be encoded in objects in object-oriented programming environment, key-value pairs, entries in a relational database, documents encoded in a hierarchical data serialization format, or combinations thereof, without being labeled as graphs.

In some embodiments, to expedite write operations (and in some cases, afford faster reads or verifications of reads), some embodiments may consolidate writes to the directed acyclic graph 105 of cryptographic hash pointers. For instance, some embodiments may form sub-graphs of directed acyclic graphs of cryptographic hash pointers that are collectively appended to an extant, larger directed acyclic graph of cryptographic hash pointers. In some embodiments, the directed acyclic graph 105 of cryptographic hash pointers may include a linked list, tree, or skip list of the sub-graphs. In some embodiments, the sub-graphs may be referred to as blocks, e.g., example blocks 11-14 as shown, with block 14 being current and blocks 11-13 storing one or more transactions, Tx 1-3, pertinent to the examples described herein, and each may include 2, 4, 8, 16, 32, 64, 128, 256, 512, 1028, or more or less nodes, and one or more of those nodes may include node content, such as a Tx 1-3. Tx 1 may include an original tile, cryptographic hash and location thereof, or other representation of the original title. Tx 2 may represent the creation of a title information record, TitleR, in the unified format, and may include a cryptographic hash pointer back to Tx 1. Tx 3 may represent a transaction indicating that some rights were conferred to another party, e.g., a subset of rights TitleR′ in the unified format.

In some cases, those transactions may utilize the ERC 721 standard, which is incorporated by reference herein. ERC 721 defines a standard for tokens, which can be used in transactional exchanges, and held in an ether wallet, like a title wallet 140. Tokens may be unique, and thus, a token may be created and include title information in the data structure 132 specified by the unified schema for a type of title. In some embodiments, some aspects, like aspects of the title information in the data structure, may be conferred to other tokens. The ERC 721 standard defines, for tokens, functions: name, symbol, totalSupply, balanceOf, ownerOf, approve, takeOwnership, transfer, to kenOfOwnerByIndex, and tokenMetadata. It also defines two events: Transfer and Approval. Tokens may be generated in association with one or more of the transactions described herein to provide representation of title information and representation of ownership for an asset, by way of a user having a token representative of an asset, that confers one or more rights, within their title wallet 140 (which may be the same as their regular ether wallet). Thus, for example, the owner of an asset may have a token representing that ownership, Tx 2 TitleR, and may later transfer some of those rights (or even the whole asset) to another party, such as by Tx 3 TitleR′. The receiving party, in some cases, may receive a token enumerating those rights that were conferred.

The present techniques may be used to record and track the flow of rights in real estate, including fee simple title, mineral rights, water rights, wind rights, easements, and revenue streams therefrom, including royalty interests in oil and gas wells other infrastructure on real estate.

FIG. 2 shows an example of a process 200 by which the above-describe techniques may be implemented to determine whether to execute a title transaction and publish the transaction to a tamper-evident, immutable, decentralized data store. In some cases, the process 200 is executed by one or more computing nodes 100 of the decentralized data store and/or an authority 130, though embodiments are not limited to that implementation, which is not to suggest that any other description herein is limiting. For example, in some cases an authority 130 may operate as, or include, a computing node 100, and in some cases, some steps may be performed by an authority 130 and some steps by a computing node 100 executing a smart contract. In some embodiments, the described functionality of FIG. 2 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 200 includes receiving, with one or more processors, a request 202 to execute a title transaction, which may be a title creation transaction for an asset or transfer of ownership or rights pertaining to an asset or portion thereof. Example steps are explained below for the process of executing a title transaction for title creation for an asset, and steps are also described for variations including transfer of ownership or rights. In some embodiments, an address of a smart contract may be called with an API call including the information described below. In some embodiments, the smart contract may respond to the API call by executing a transaction on the blockchain that records information to the blockchain. In some embodiments, the smart contract may perform one or more API requests to other entities to retrieve some of the information described below for processing. For example, a request may specify storage locations of some information and the smart contract may be configured to retrieve that data. All or a subset of the information may also be provided in a request.

In some embodiments, the process 200 includes determining a transaction cost 204. In some embodiments, gas is used to pay the miners who are doing the computations for title transactions in the ether chain. This may be implemented using Sload and Sstore computations, for which gas is provided to pay the miners performing those operations. In some embodiments Sstore is used for the initial creation and Sload for the verification of titles. Txdata, in some embodiments, can be used for initial creation because of a size of the bytes for some initial creations, depending on the embodiment. The transaction cost 204 may be determined based on the amount of gas required to pay for the transaction, such as based on a current cost of an Sstore function and optionally a Txdata function. The cost of the Sstore function may be fixed or variable (e.g., fixed in ether but variable in other currencies and/or fixed or variable based on the data being stored). Similarly, the Txdata function may be fixed or variable, but may also be variable based on an amount of data being stored, such as where the size of data being stored exceeds a limit associated with the Sstore function.

In some embodiments, determining transaction cost 204 comprises obtaining a title 205 or representation thereof. For example, the request 202 may specify a title location (e.g., a URL or other storage location of the record, which may correspond to a file stored by an authority) or otherwise include title information, such as file corresponding to the title. In embodiments, such as where the obtained title information (e.g. a title in the title schema, which may be a file corresponding to the title) is stored to the blockchain, determining transaction cost 204 may comprise a computing of an amount of gas required to perform a Txdata function for storing the obtained title information, and the amount of gas required may correspond to a size of the obtained title if stored in the obtained schema. Title information may also be stored in the unified schema, which may have a data size compatible with a Sstore function. Thus, the transaction cost, or amount of gas required, may be a sum of the gas required to perform one or more functions for storing the title information to the blockchain. For example, the Txdata function may be utilized to store title information as obtained and the Sstore function utilized to store title information in the unified schema.

In embodiments where the transaction for a transfer of ownership or rights pertaining to an asset that has already been stored in the blockchain, the obtained title may be a title transaction record in the unified schema having been stored in the blockchain. As such, the transaction cost 204 may not store obtained title information in duplicate, thus minimizing cost by reducing utilization of the Txdata function for subsequent transactions pertaining to titles already transacted in the blockchain. However, in some embodiments, such as for a title creation transaction that augments an asset having title information recorded in the blockchain with one or more assets (e.g., a property owner purchases an adjacent property or rights to an adjacent property), the Txdata function may be utilized to store the off-blockchain obtained title information to the blockchain, and further, at least one subsequent Sstore function may be utilized for title creation transaction in the unified format. Further, in some embodiments, where the transaction includes existing on-blockchain title information in the unified schema, costs associated with a title verification process may be factored into the transaction costs (e.g., as described with reference to FIG. 3).

In embodiments where the title information is stored on-blockchain, the request 202 may reference one or more title transaction by address in the decentralized data store, by which the title information may be obtained 205. For example, accessing the first record, the first record including title information in the unified schema, which may implicate a prior transaction (e.g., original title information or prior transactions linking back to the original title information) published to the tamper-evident, immutable, data store in at least one record.

In some embodiments, the process 200 includes translating 206 and obtained title to the unified schema. For title creation transactions, the translating 206 may comprise translating the title information from the schema of the obtained title to the unified schema for the title type.

In some embodiments, title information (e.g., defining the metes and bound of land, the set of rights conveyed, the date of transfer, and nature of the transfer (e.g., fee simple, security interest, lease, life estate, etc), address of the conveyor, address of the recipient, and address of a previous document or set of documents conveying the transferred rights to the conveyor) may be obtained in a document, such as scanned written document, or other data format, and translated to the unified schema. For example, the obtained title information may be parsed to identify keys in the schema of the title and values corresponding to those keys. In turn, those identified keys and their corresponding values may be translated into key-value pairs in the unified schema. Further, those key-values pairs may structured hierarchically in the unified schema. The resulting key-value pairs in the unified schema may be processed into a data structure specified by the unified schema for storing title information, such as XML or JSON code or a vector descriptive of the asset and ownership.

In some embodiments, the process 200 includes verifying requirements 208 for executing the requested transaction. For example, requirement verification 208 may include determining whether transaction fees 207 are available for processing the transaction. This may include checking that a balance of a wallet associated with the entity requesting the transaction has available funds to cover the transaction costs determined at block 204. In some embodiments, the verifying requirements 208 includes verifying a signature associated with the request. For example, for a title creation transaction, one or more signatures associated with the request may be required to process the transaction. In some embodiments, a signature corresponding to a signature authority may be required along with a signature corresponding to an entity (e.g., the owner of the asset), where the signature authority verifies the identity of the entity, and may also verify ownership of the asset by the entity off-blockchain. In some embodiments, the verifying requirements 208 includes verification of the signature of the signature authority. In this way, transaction processing may be restricted to only those signature authorities deemed reputable. The signature corresponding to the entity may serve to show ownership of the asset to which the title information corresponds.

In some embodiments, some transactions for on-blockchain title information may be processed based on a signature corresponding to the entity without requiring signature of an authority, but others may require signature of an authority. For example, the requirements verification 208 may determined whether signature of an authority (or additional entity) is required. This verification may include determining whether the title information in the unified schema indicates the entity is permitted to request the transaction. For example, the entity may not be permitted to transfer a title to another entity if the title information in the unified schema indicates that a bank or other party has a financial interest in the asset. However, that same entity may be permitted to transfer rights (like drilling or mining rights) to another entity. Thus, the verify requirements 208 may verify the request for executing the title transaction does not go beyond the rights retained by the entity requesting the transaction.

In some embodiments, the process 200 includes determining 210 with one or more processors, whether to execute the requested transaction based on the result of the requirement verification at step 208. If the requirements are not verified, the request may be rejected 216. The rejection may specify the requirements not met during verification. If the requirement are verified, the request may be effected as a transaction in blockchain 212. For example, one or more transactions effecting the request may be published to a tamper-evident, immutable, decentralized data store. For example, for a title creation transaction, original title information may be stored (e.g., published) to the data store or blockchain with a Txdata function, and title information in the unified schema may be formatted into a data structure, like XML or JSON code, or a vector, and stored (e.g., published) to the data store or blockchain with a Sstore function. The transaction fees 207 verified at step 208 can be utilized to provide the gas for effectuating the transactions 212, such as by deducting the amount of gas from the wallet for the respective functions.

In some embodiments, a smart contract may respond to an API call by executing a transaction on the blockchain that records title information to the blockchain. This, in some cases, may include calculating a cryptographic hash value based on both the title information and a cryptographic hash value of transactions in the block chain through which the conveyed rights were previously conveyed to the conveyor (such as by previous transactions pertaining to on-blockchain title information and/or transaction storing original title information). In some cases, a new entry created by the smart contract may include this cryptographic hash value and pointers to those other nodes. In some embodiments, every computing device executing a decentralized application implementing the block chain may execute a routine specified by the smart contract, and some embodiments may implement a consensus algorithm among those computing devices, like Paxos or Raft, to reach a consensus as to a result of executing the smart contract. The result may be stored in the blockchain and this process may be repeated for subsequent transfers. Some embodiments may interrogate these records to verify title, e.g., by recreating the calculation of the cryptographic hash values along each link in a chain of cryptographic hash pointers and comparing the recalculated values to the values in the chain to confirm (in virtue of matches) that the records are authentic.

In some embodiments, the process 200 include returning authorization 214 for the processing of the transactions. In some cases, returning authorization 214 comprises monitoring the blockchain to determine that the transactions have been published. In some cases, returning authorization 214 comprises monitoring the blockchain to determine that the transactions have been published to a block of the blockchain and are considered authoritative. The returned authorization 214 may comprises one or more of a transaction ID and title information ID, where the title information ID is a location of the title transaction published to the blockchain and considered authoritative.

The present techniques may be used to record and track the flow of rights in real estate, including fee simple title, mineral rights, water rights, wind rights, easements, and revenue streams therefrom, including royalty interests in oil and gas wells other infrastructure on real estate.

FIG. 3 shows an example of a process 300 by which the above-describe techniques may be implemented to verify title ownership based on records documenting title information associated with an asset and published to a tamper-evident, immutable, decentralized data store. In some cases, the process 300 is executed by one or more computing nodes 100 of the decentralized data store and/or an authority 130, though embodiments are not limited to that implementation, which is not to suggest that any other description herein is limiting. For example, in some cases an authority 130 may operate as, or include, a computing node 100, and in some cases, some steps may be performed by an authority 130 and some steps by a computing node 100 executing a smart contract. In some embodiments, the described functionality of FIG. 3 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 300 includes receiving, with one or more processors, a request 302 to verify title ownership for on-blockchain title information. In some embodiments, an address of a smart contract may be called with an API call including the information described below. In some embodiments, the smart contract may respond to the API call by executing a transaction on the blockchain that records information to the blockchain. In some embodiments, the smart contract may perform one or more API requests to other entities to retrieve some of the information described below for processing. For example, a request may specify storage locations of some information and the smart contract may be configured to retrieve that data. All or a subset of the information may also be provided in a request.

In some embodiments, the process 300 includes determining a transaction cost 304. In some embodiments, gas is used to pay the miners who are doing the computations for title verification in the ether chain. This may be implemented using Sload and Sstore computations, for which gas is provided to pay the miners performing those operations. In some embodiments Sstore is used for the initial creation and Sload for the verification of titles. The cost of the Sload function may be fixed or variable (e.g., fixed in ether but variable in other currencies and/or fixed or variable based on the data being verified).

In embodiments where the title information is stored on-blockchain, the request 302 may reference one or more title transaction by address in the decentralized data store, by which the title information may be obtained 305. For example, accessing the first record, the first record including title information in the unified schema, which may implicate a prior transaction (e.g., original title information or prior transactions linking back to the original title information) published to the tamper-evident, immutable, data store in at least one record.

In some embodiments, determining transaction cost 304 comprises obtaining 305 a title information record or location of representation thereof. For example, the request 302 may specify a title information location(s) on-blockchain, which may contain the title information and/or a cryptograph hash in conjunction with another storage location of the title information, which may correspond to a file stored by an authority. Where the obtained title information is stored on the blockchain in the unified schema, determining transaction cost 204 may comprise a computing an amount of gas required to perform an Sload function for verifying authenticity of the title information on-blockchain. In some embodiments, the transaction cost 204 may comprises a computing an amount of gas required to verify off-blockchain information, such as by computing a computing of an amount of gas required to cryptographically hash off-blockchain files for comparison to one or more on-blockchain cryptographic hashes representative of those files.

In some embodiments, the process 300 includes verifying requirements 308 for executing the requested transaction. For example, requirement verification 308 may include determining whether transaction fees 307 are available for processing the transaction. This may include checking that a balance of a wallet associated with the entity requesting the transaction has available funds to cover the transaction costs determined at block 304. In some embodiments,

In some embodiments, title information (e.g., defining the metes and bound of land, the set of rights conveyed, the date of transfer, and nature of the transfer (e.g., fee simple, security interest, lease, life estate, etc), address of the conveyor, address of the recipient, and address of a previous document or set of documents conveying the transferred rights to the conveyor) is stored on blockchain in the unified schema. Further, key-value pairs representing information like that above may structured hierarchically according to the unified schema.

In some embodiments, requirement verification 308 may include determining whether the title information meets one or more requirement specified in the verification request. Thus, for example, if the record of the title information on-blockchain does not meet one or more requirements specified in the verification request, the process 300 may determine 310, with one or more processors, to reject 314 the request. In this way, on-blockchain operations may be avoided if the title information does not meet requirements for which it is being verified, and utility is increased. In other words, if an entity wishes to verify ownership for a specific purpose, if the title information record indicates that purpose is not permitted, ownership verification need not be performed. For example, title information may specify that the owner is not permitted to transfer rights (like drilling or mining rights) to another entity. Thus, the verify requirements 308 may verify the title information meets one or more requirements that may be specified in the request in some embodiments prior to proceeding to ownership verification. The one or more requirements may be specified in the uniform schema such as to afford comparison with title information stored on-blockchain according to the data structure specified by the unified schema.

In some embodiments, the process 300 includes determining 310 with one or more processors, whether to execute the requested transaction based on the result of the requirement verification at step 308. If the requirements are not verified, the request may be rejected 314. The rejection may specify the requirements not met during verification. If the requirement are verified, the request may be effected as a transaction in blockchain for verifying title ownership 312. For example, the transaction fees 307 verified at step 308 can be utilized to provide the gas for effectuating one or more transactions for performance of sload functions, such as by deducting the amount of gas from the wallet for one or more sload functions.

In some embodiments, the process 300 includes determining 316, with one or more processors, whether the title information obtained at step 305 is verified on the blockchain. If the title information is not verified, authorization 320 is rejected. Verification may fail as a result of one or more later transactions pertaining to the obtained title information stored on the blockchain (e.g., no longer current), or being unable to verify one or more earlier transactions to establish the prominence of the obtained title information back to the original record thereof in blockchain. In some cases, returning authorization 318 is provided when the title information is verified by receiving a result based on the execution of the sload function according to a smart contract where that result indicates the title information 305 as published to the blockchain is considered authoritative. The result may comprise the chain of transactions pertaining to the title information.

In some embodiments, a smart contract may respond to an API call by executing a transaction on the blockchain that verifies title information to the blockchain. This, in some cases, may include calculating a cryptographic hash value based on both the title information and a cryptographic hash value of transactions in the block chain through which the conveyed rights were previously conveyed to the conveyor (such as by previous transactions pertaining to on-blockchain title information and/or transaction storing original title information). In some embodiments, every computing device executing a decentralized application implementing the block chain may execute a routine specified by the smart contract, and some embodiments may implement a consensus algorithm among those computing devices, like Paxos or Raft, to reach a consensus as to a result of executing the smart contract. In some embodiments, the verification result may be stored in the blockchain and its location provided as return authorization 318 or the result may be returned as authorization 318. Some embodiments may interrogate these records to verify title, e.g., by recreating the calculation of the cryptographic hash values along each link in a chain of cryptographic hash pointers and comparing the recalculated values to the values in the chain to confirm (in virtue of matches) that the records are authentic.

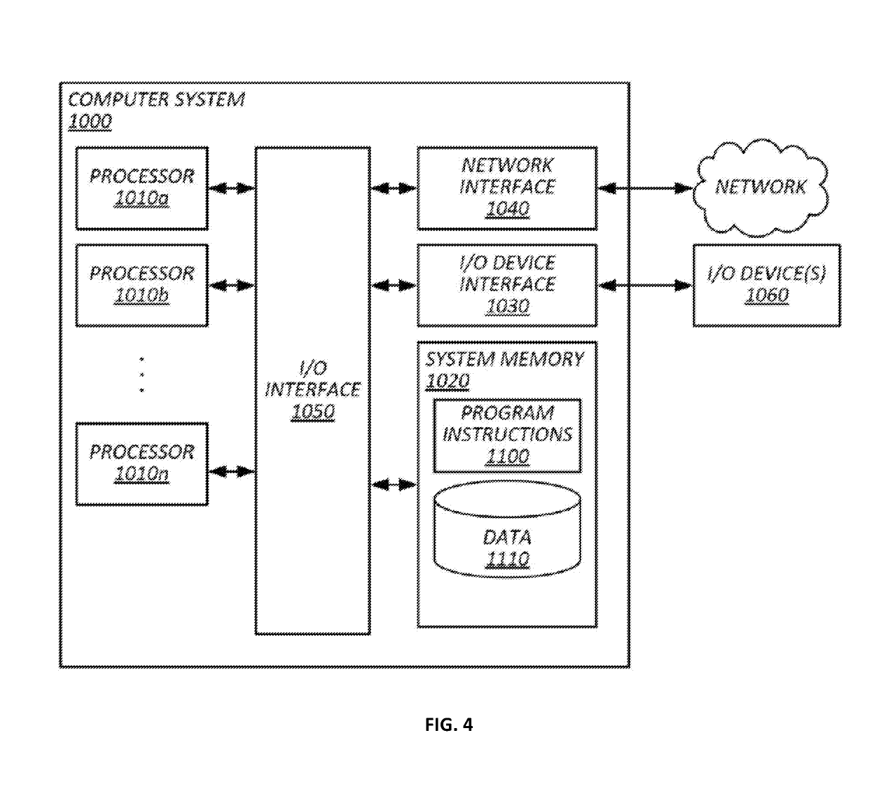

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, where certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method of determining whether to effectuate a transaction published on-blockchain in a tamper-evident, immutable, decentralized data store and recording a title showing ownership of an asset, the method comprising:
receiving, with one or more processors, a request to execute a title transaction;
obtaining, with one or more processors, a title associated with the request and showing ownership of an asset by an entity, the title being off-blockchain;
determining, with one or more processors, a cost for effecting one or more transaction to store the title on-blockchain, wherein determining the cost comprises determining a first subcost for storing title information in a unified schema and a second subcost for storing the obtained title;
translating, with one or more processors, the obtained title based on the unified title schema, the translating comprising determining the title information in the unified schema from the obtained title, the unified schema specifying permitted key-value pairs in a data structure;
verifying, with one or more processors, requirements for the title transaction based on a request type, wherein the request type is a create title request and verifying:
a cryptographic signature of an authority,
a cryptographic signature of the entity, and
availability of funds equal or greater to the determined cost in a wallet associated with the entity,
effectuating a first transaction to store the obtained title on-blockchain; and
effectuating a second transaction to store the data structure on-blockchain, where the second transaction causes a deduction at least the first subcost from the wallet of the entity, the data structure comprising a cryptographic hash pointer to a location of the obtained title on-blockchain, and wherein the second transaction enumerate ownership of the asset by the entity on-blockchain.
